(19) United States
(12) Patent Application Publication
(10) Pub. No.: US 2015/0139473 A1
(43) Pub. Date: May 21, 2015

(54) HEADSET WITH BALL JOINT ALLOWING ROTATION OF EARPIECES IN MULTIPLE AXES

(71) Applicant: Stephen R. Jaynes, Pleasant Grove, UT (US)

(72) Inventor: Stephen R. Jaynes, Pleasant Grove, UT (US)

(21) Appl. No.: 14/514,344

(22) Filed: Oct. 14, 2014

Related U.S. Application Data
(60) Provisional application No. 61/890,828, filed on Oct. 14, 2013.

(51) Int. Cl. H04R 1/10

(52) U.S. Cl. CPC H04R 1/10
USPC 381/379

(57) ABSTRACT

A headset comprising a ball joint that connects the an earpiece with an earpiece support is described herein. While the headset can include any suitable component, in some cases, it includes an earpiece that configured to be worn in close proximity to a user's ear, an earpiece support configured to attach to a user's head, and a ball joint that adjustably couples the earpiece to the earpiece support. In some such embodiments, the ball joint further includes a rounded object and a first and a second extension that are configured to apply pressure to the rounded object to adjustably hold the earpiece in relation to the earpiece support. In some cases, by using the ball joint, the earpieces can be rotated in multiple axes, thereby allowing users to position the earpieces in many orientations. Other implementations are described.

### CROSS-REFERENCE TO RELATED APPLICATION

This application claims priority to U.S. Provisional Patent Application Ser. No. 61/890,828, filed Oct. 14, 2013, and entitled “HEADPHONES WITH BALL JOINT ALLOWING ROTATION OF SPEAKER UNITS IN MULTIPLE AXES” (Attorney Docket No. 7688.54); the entire disclosure of which is hereby incorporated by reference.

### BACKGROUND OF THE INVENTION

1. Field of the Invention

The present invention relates to headsets. In particular, some implementations of the present invention relate to systems and methods for providing a headset with one or more speakers and/or other earpieces that are connected to a headband (or other earpiece support) via one or more ball joints. In some such implementations, the ball joints allow the earpieces to be moved into (and to be held in) a wide variety of orientations.

2. Background and Related Art

Headphones typically include a pair of relatively small loudspeakers that are configured to be held in close relation to a user's ears. Moreover, many headphones are configured to convert electrical signals from a media device (e.g., a portable media device, mobile phone, computer, radio, amplifier, electronic musical instrument, CD player, gaming system, car stereo, etc.) into sound. Furthermore, as part of their design, many headphones allow their users to hear the sounds being provided by the headphones, while those around such users hear little to no sound coming from the headphones.

In a day when media devices abound, headphones are commonplace. Indeed, in many cases, headphones are worn regularly: as part of many people's normal attire, for work, during commuting (e.g., when riding public transit), during exercise, during relaxation, and in a many other circumstances.

Despite their popularity, utility, and almost ubiquitous use, headphones are not necessarily without their shortcomings. By way of example, while some headphones are configured to be worn on heads having a relatively large range of sizes and shapes, many people may still find such headphones uncomfortable. In another example, while some headphones may be configured to listened to while such headphones are worn on a user's head, in some cases, it may be difficult to turn the headphones speakers into a desired orientation when the headphones are being used around the user's neck and/or in some other location or orientation.

Thus, while techniques currently exist that are used to hold headphone speakers in proximity to a user's ears, challenges still exist, including those discussed above. Accordingly, it would be an improvement in the art to augment or even replace current techniques with other techniques.

### BRIEF SUMMARY

The present invention relates to headsets. In particular, some implementations of the present invention relate to systems and methods for providing a headset with one or more speakers and/or other earpieces that are connected to a headband (or other earpiece support) via one or more ball joints. In some such implementations, the ball joints allow the earpieces to be moved into (and to be held in) a wide variety of orientations.

In some implementations, the present invention includes a headset comprising one or more earpieces, earpiece supports, and ball joints that are configured to adjustably connect an earpiece to a corresponding earpiece support. With reference to the earpiece, the earpiece can comprise virtually any suitable earpiece that can be held by the earpiece support in relatively close proximity to a user's ear. Some examples of suitable earpieces include, but are not limited to, one or more headphones (e.g., circumaural headphones, supra-aural headphones, closed-back headphones, open-back headphones, semi-open headphones, ear-fitting headphones, etc.), telephone headsets, headphone/microphone combinations, earpads, earmuffs, earplugs, ear caps, hearing protectors, earbuds, stabilizing objects that are configured to help hold the earpiece support to a user's head, and/or other suitable objects that are configured to be held close to at least one of a user's ears. In some implementations, however, each earpiece comprises a headphone with at least one speaker unit.

With reference to the earpiece support, the earpiece support can comprise any suitable object that is configured to hold an earpiece in proximity to a user's ear. In this regard, some examples of suitable earpiece supports comprise a band (including, without limitation, a headband comprising band that is substantially C-shaped and/or U-shaped and that is configured to extend over the top of, around the back of, and/or around another portion of a user's head, neck, and/or face; a headband that is configured to circumscribe a portion of a user's head, face, and/or neck; and/or any other suitable headband), a hat, a hard hat, a helmet, a headpiece, a cap, a neckband, and/or any other suitable object that is configured to allow the described headset to function as intended.

With respect to the ball joints, each ball joint can comprise any suitable feature that allows it to adjustably attach an earpiece to the earpiece support. In some implementations, each ball joint comprises a sphere, ellipsoidal object, egg-shaped object, and/or other rounded object that is attached to either the earpiece or a corresponding portion of the earpiece support. Additionally, in some implementations, each ball joint further comprises at least two extensions (e.g., a first and a second extension) that extend from the other of the earpiece and the earpiece support and which are configured to pinch or otherwise exert pressure on the rounded object to adjustably maintain the earpiece in a desired location with respect to the earpiece support.

The extensions can exert pressure on the rounded object of the ball joint in any suitable manner. Indeed, in some implementations, a portion of one or more of the extensions is biased towards a portion of another extension, such that the first and second extensions are able to pinch the rounded object to adjustably secure an earpiece in place. In other implementations, each ball joint comprises a tension screw, a spring-loaded clamping mechanism, a ratchet mechanism, and/or any other suitable tensioning means that allows the pressure exerted on the rounded object to selectively be adjusted such that an earpiece can be moved to and held in multiple desired positions.

In still other implementations, the headset comprises means for reducing the pressure applied by the first and second extensions on a corresponding rounded object to allow movement between the rounded object and the first and second extensions. In this regard, the pressure reducing means can comprise any suitable object or mechanism that allows it to reduce pressure between the rounded object and the first and second extensions. Some examples of such pressure reducing means comprises a lever, a clamp release, a screw and/or other threaded member, a pinch mechanism that reduces pressure when pinched, and/or any other suitable mechanism that allows a user to selectively reduce and/or increase pressure between the extensions and the corresponding rounded object when desired.

Thus, in at least some implementations, the present invention extends to headsets that employ a ball joint for connecting one or more speaker units or other earpieces to a band or other headpiece support. By using the described ball joint, the earpieces (e.g., speaker units) may be rotated in multiple axes, thereby allowing users to position the speaker units in a wide variety of orientations. As such, the headsets can be worn comfortably by virtually any user (e.g., on a user's head, around a user's neck, and/or otherwise).

This summary is provided to introduce a selection of concepts in a simplified form that are further described below in the Detailed Description. This summary is not intended to identify key features or essential features of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates a front elevation view of a headset that employs ball joints to attach earpieces to a band in accordance with some embodiments of the invention;

FIG. 1B illustrates a close-up perspective view of a representative embodiment of a ball joint;

FIG. 1C illustrates a perspective view of a speaker unit in accordance with some embodiments of the invention;

FIG. 1D illustrates a side elevation view of a representative embodiment of the headset;

FIG. 1E illustrates a side elevation view of a representative embodiment of the headset, showing various axes around which the ball joint can enable the earpieces to be rotated;

FIG. 2 illustrates an exploded view of a representative embodiment of the headset;

FIG. 3 illustrates a perspective view of representative embodiment of the headset, illustrating how the ball joints allow the earpieces to be rotated in accordance with some embodiments;

FIG. 4 illustrates a perspective view of representative embodiment of headset, showing how the some embodiments of the ball joints allow the earpieces to be rotated;

FIG. 5 illustrates a perspective view of a representative embodiment of the headset; and

FIGS. 6 and 7 illustrate various dimensions for headsets that employ the ball joint in accordance with some embodiments.

### DETAILED DESCRIPTION

The present invention relates to headsets. In particular, some implementations of the present invention relate to systems and methods for providing a headset with one or more speakers and/or other earpieces that are connected to a headband (or other earpiece support) via one or more ball joints. In some such implementations, the ball joints allow the earpieces to be moved into (and to be held in) a wide variety of orientations.

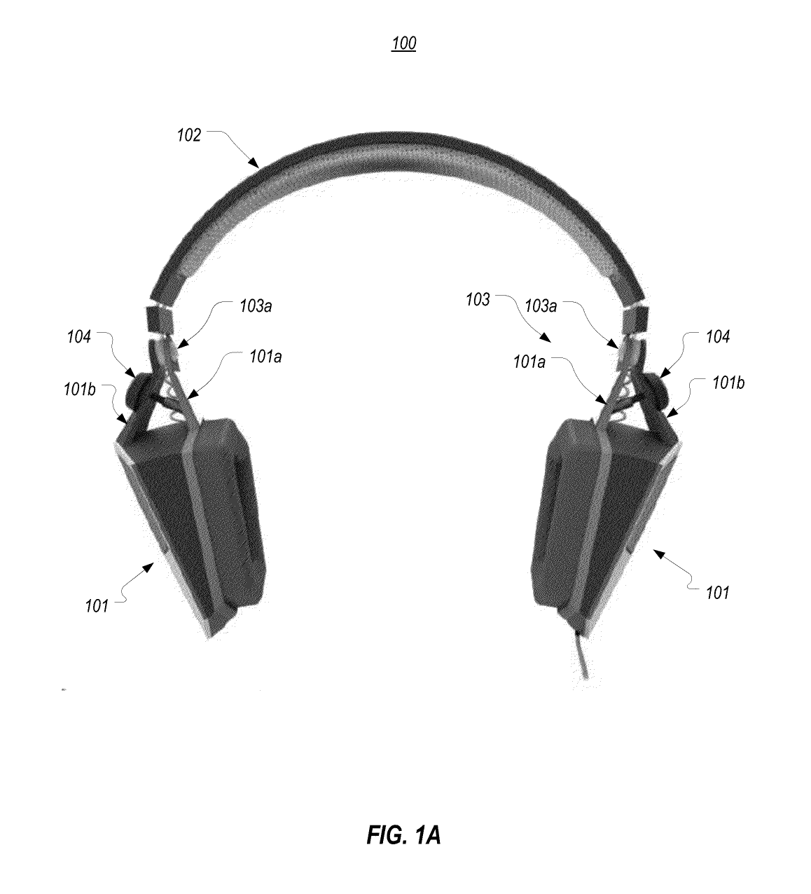

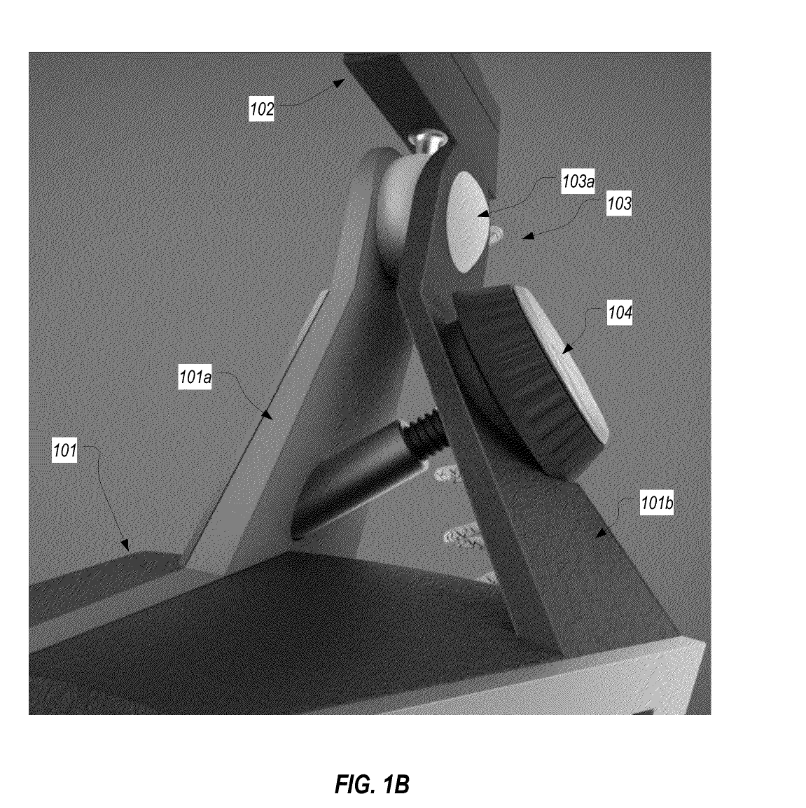

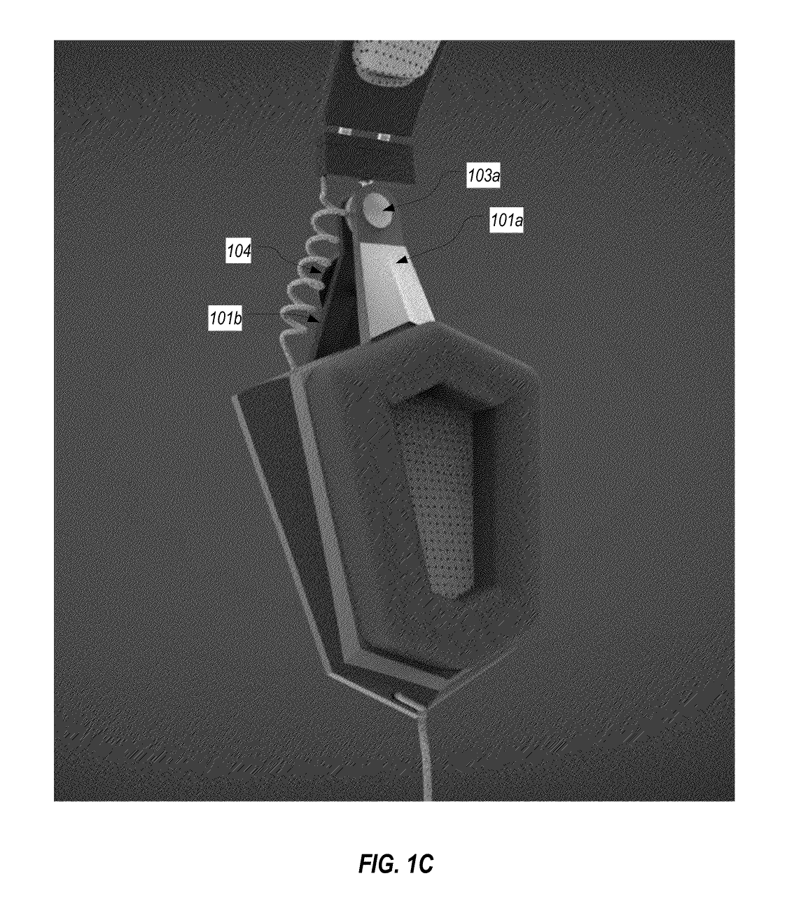

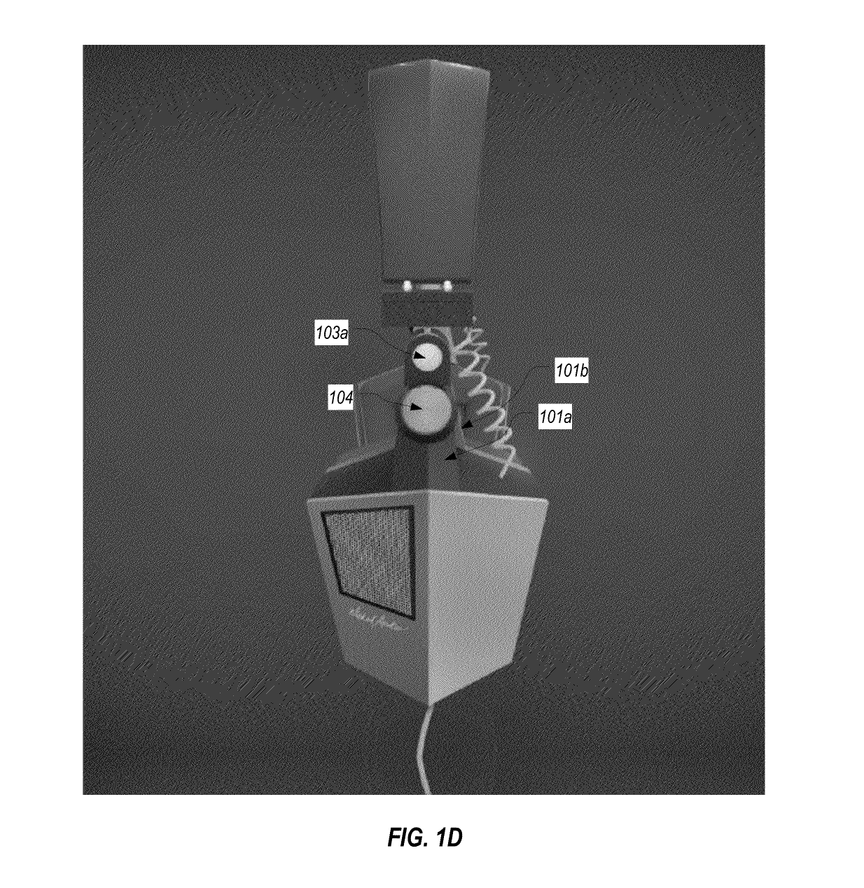

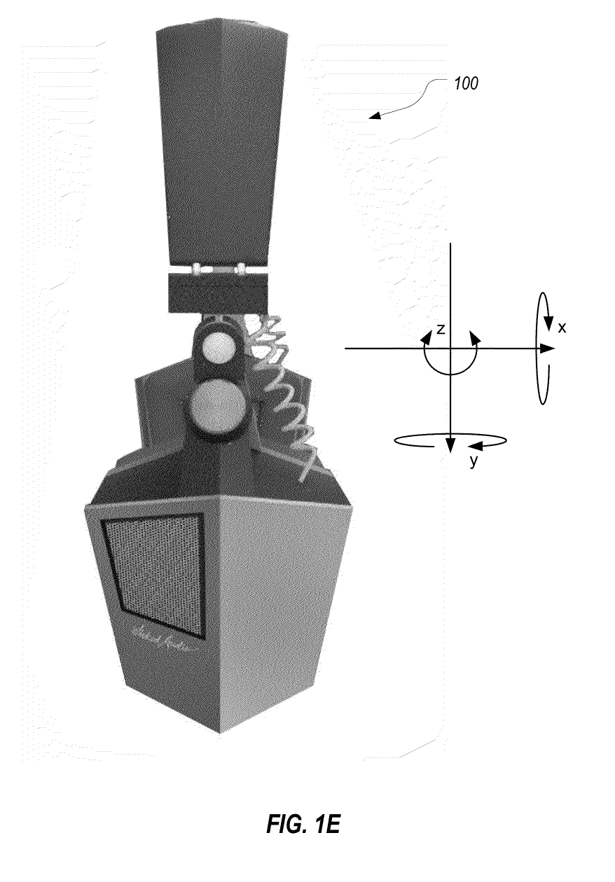

As used herein, the term headset and variations thereof may refer to an object that is configured to hold one or more earpieces (as described below) in close proximity to a user's ear. While the headset described herein can include any suitable feature, FIGS. 1A-1E show that, in some embodiments, the described headset 100 comprises one or more earpieces 101, earpiece supports 102, and ball joints 103, wherein the ball joints are configured to adjustably attach the earpieces to the earpiece supports.

With regard to the earpieces 101, each earpiece can comprise virtually any suitable object that can be held by the earpiece support 102 in relatively close proximity to a user's ear. Some examples of such earpieces include, but are not limited to, one or more headphones (e.g., circumaural headphones, supra-aural headphones, closed-back headphones, open-back headphones, semi-open headphones, ear-fitting headphones, speakers, etc.), telephone headsets, headphone/microphone combinations, earpads, earmuffs, earplugs, earbuds, ear caps, stabilizing members that are configured to help hold the earpiece support to a user's head, and/or other suitable objects that are configured to be held close to at least one of a user's ears. In accordance with some embodiments, however, FIG. 1A shows that each earpiece 101 comprises a headphone with at least one speaker unit. Additionally, while some embodiments of the headset 100 comprise a single earpiece (e.g., a single headphone for either of a user's right or left ears), FIG. 1A shows that, in some embodiments, the headset 100 comprises two earpieces 101.

While the earpieces can comprise any suitable component or characteristic, in some embodiments, they comprise one or more internal speakers that are configured to provide sound to a user's ears when the earpieces are worn over the user's ears. In some embodiments, however, the earpieces comprise one or more external speakers that are configured to provide sound at a relatively high volume when the earpieces are not worn directly on the user's ears (e.g., when the headset is worn about a user's neck, carried in a user's hand, set down, etc.).

With respect to the earpiece support 102, the earpiece support can comprise any suitable object that is configured to hold one or more earpieces 101 in proximity to at least one of a user's ears. In this regard, some examples of suitable earpiece supports comprise a band (including, without limitation, a headband that is substantially C-shaped and/or U-shaped and that is configured to extend over the top of, around the back of, and/or around another portion of a user's head, neck, and/or face; an adjustable band; a band that is configured to circumscribe a portion of a user's head, face, and/or neck; and/or any other suitable band), a hat, a hard hat, a helmet, a headpiece, a cap, a neckband, and/or any other suitable object that is configured to allow the described headset 100 to function as intended. By way of non-limiting illustration, FIG. 1A shows that, in some embodiments, the earpiece support 102 comprises an adjustable band that is configured to extend over a portion of a user's head, face, and/or neck.

With reference to the ball joint 103, the headset 100 can comprise any suitable number of ball joints, which connect each earpiece 101 to the earpiece support 102. In this regard, while some embodiments comprise 2, 3, 4, or more ball joints between each earpiece and the earpiece support, FIG. 1A shows some an embodiment in which the headset 100 comprises a single ball joint 103 between the earpiece 101 and the earpiece support 102.

Each ball joint 103 can comprise any suitable feature that allows it to adjustably attach an earpiece 101 to the earpiece support 102. In some implementations, each ball joint comprises a spherical object, an ellipsoidal object, an egg-shaped object, a rounded object with a ring and/or ridge about it, and/or any other suitable rounded object that is configured to allow an earpiece to pivot about the rounded object in multiple axes. In accordance with at least some embodiments, however, FIG. 1B shows that the rounded object 103a comprises a spherical object.

The rounded object 103a can comprise any suitable material that allows it to function as intended. In this regard, some examples of suitable materials include, one or more metals, ceramics, plastics, rubbers, synthetic materials, woods, and/or any other suitable material or materials. In some embodiments, however, the rounded object comprises a rubber and/or a material with a relatively high coefficient of friction that helps ensure that the orientation of the earpieces is only changed when desired.

The rounded object 103a in the ball joint 103 can be attached (e.g., fixedly or otherwise attached) to any suitable portion of the headset 100. Indeed, in some embodiments, the rounded object of a ball joint is fixedly attached to the earpiece 101. In accordance with other embodiments, however, FIG. 1B shows that, in some cases, the rounded object 103a of the ball joint 103 is fixedly attached to the earpiece support 102. Moreover, FIG. 1A shows that, in some embodiments, each ball joint 103 comprises a rounded object 103 (e.g., a ball) that is attached to the end of the earpiece support 102 (e.g., a band).

In addition to the rounded object 103a, in some embodiments, the ball joints 103 further comprise at least two extensions (e.g., a first and a second extension) that are configured to pinch or otherwise exert pressure on an external surface of the rounded object to adjustably maintain the earpiece 101 in a desired location with respect to the earpiece support 102.

The extensions in the ball joint 103 can have any characteristic or component that allows them to function as intended. Indeed, although, in some embodiments, the extensions extend from the earpiece support 102, FIG. 1B shows an embodiment in which the first 101a and second 101b extensions extend from (and are fixedly or otherwise coupled to) the earpiece 101.

The extensions (e.g., the first 101a and second 101b extensions) can further be any suitable shape that allows them to be used to selectively and adjustably fix the earpiece 101 in relation to the earpiece support 102. For instance, the extensions can be straight, curved, angled, rounded, and/or have any other suitable shape. By way of non-limiting example, FIG. 1B, which illustrates a close-up view of a representative embodiment of the ball joint 103, shows that at least one of the extensions (e.g., the first 101a and second 101b extensions) includes an inwardly angled portion and a flat portion.

The extensions (e.g., the first 101a and second 101b extensions) can further comprise any suitable surface for interfacing with the rounded object 103a, including, without limitation, a hole or recess into which the rounded object extends. In this regard, FIG. 1B depicts an embodiment in which the flat portion of the first 101a and second 101b extensions includes a hole through which a portion of the rounded object 103a extends when the first and second extensions are secured overtop of the rounded object.

The extensions (e.g., the first 101a and the second 101b extensions) can exert pressure on the rounded object 103a of the ball joint 103 in any suitable manner. Indeed, in some implementations, a portion of one or more of the extensions is biased towards a portion of the other extension, such that the first and second extensions are able to pinch the rounded object to adjustably secure an earpiece 101 in place. In other implementations, each ball joint comprises a tension screw, a spring-loaded clamping mechanism, a ratchet mechanism, and/or any other suitable tensioning means that allows the pressure exerted on the rounded object to be adjusted such that an earpiece can be moved to and held in multiple desired positions. Indeed, in some embodiments, the relative position of the first 101a and second 101b extensions can create sufficient inward force on the rounded object 103a when the extensions are positioned overtop of rounded object that a separate component (e.g., tension screw 104) is not be required. In other words, in some embodiments, the inward force applied by the extensions on the rounded object may be sufficient to prevent movement unless movement is desired. Similarly, in some embodiments, one or more biasing components (e.g., springs, resilient members, detents, etc.) are employed to apply a biasing force on one or both extensions. In such cases, the biasing components can be configured to allow a user to reduce the biasing force to enable movement of earpieces 101.

In accordance with some embodiments, FIG. 1B shows that a tension screw 104 or other tensioning means can be used to force the first 101a and second 101b extensions together to prevent relative movement between the rounded object 103a and the extensions. In some such embodiments, with the tension screw 104 loosened, a corresponding earpiece 101 can be repositioned as desired. Additionally, in some such embodiments, once the desired positioning has been obtained, the tension screw 104 is tightenable to impede further movement of the earpiece 101 with respect to the earpiece support 102 (e.g., the headband).

Where the tensioning means comprises a tension screw 104, the tension screw can be attached to the headset 100 in any suitable location that allows it function as intended. In this regard, FIG. 1B shows an embodiment in which the tension screw 104 is connected to the first extension 101a. However, in other embodiments, the tension screw 104 is connected to the second extension 101b, directly to the body of an earpiece 101, and/or to any other suitable component.

In some embodiments, the headset 100 comprises means for reducing the pressure applied by the first 101a and second 102b extensions on the rounded object 103a to allow movement between the rounded object of a ball joint and a corresponding first and second extensions (or, in other words, to allow the earpiece 101 to be moved with respect to the earpiece support 102). In this regard, the pressure reducing means can comprise any suitable object or mechanism that allows it to reduce pressure between the rounded object and the first and second extensions. Some examples of such pressure reducing means comprises a lever, a clamp release, a screw and/or other threaded member, a pinch-release mechanism, and/or any other suitable mechanism that allows a user to selectively reduce and/or increase pressure between the extensions and the corresponding rounded object when desired. Indeed, in some embodiments, the first and second extensions are biased away from each other and the tensioning screw acts both as part of the tensioning means (e.g., when the screw is tightened) and as part of the pressure reducing means (e.g., when the screw is loosened).

FIG. 1E illustrates how, in accordance with some embodiments, the ball joint 103 allows the earpiece 101 to be rotated in multiple axes. When viewing the headset 100 from the side, the x axis can be defined as running left to right, the y axis can be defined as running up and down, and the z axis can be defined as extending into and out from the Figure. In some embodiments, by employing the ball joint, the earpiece is able to be repositioned in any of the three axes via the single ball joint. In other words, in some such embodiments, a single ball joint enables relative movement of the earpiece 101 in any of the three axes.

Although existing headphones often allow movement of the speaker unit in multiple axes, some of these headphones employ multiple joints (i.e., one joint per axis) to enable such movement and are therefore relatively complex. Additionally, with the additional components and complexity required to enable movement in multiple axes, some such existing designs have a relatively high likelihood of breaking. In contrast, some embodiments of the ball joint 103 design of the present invention provides a single joint design that is simple and robust.

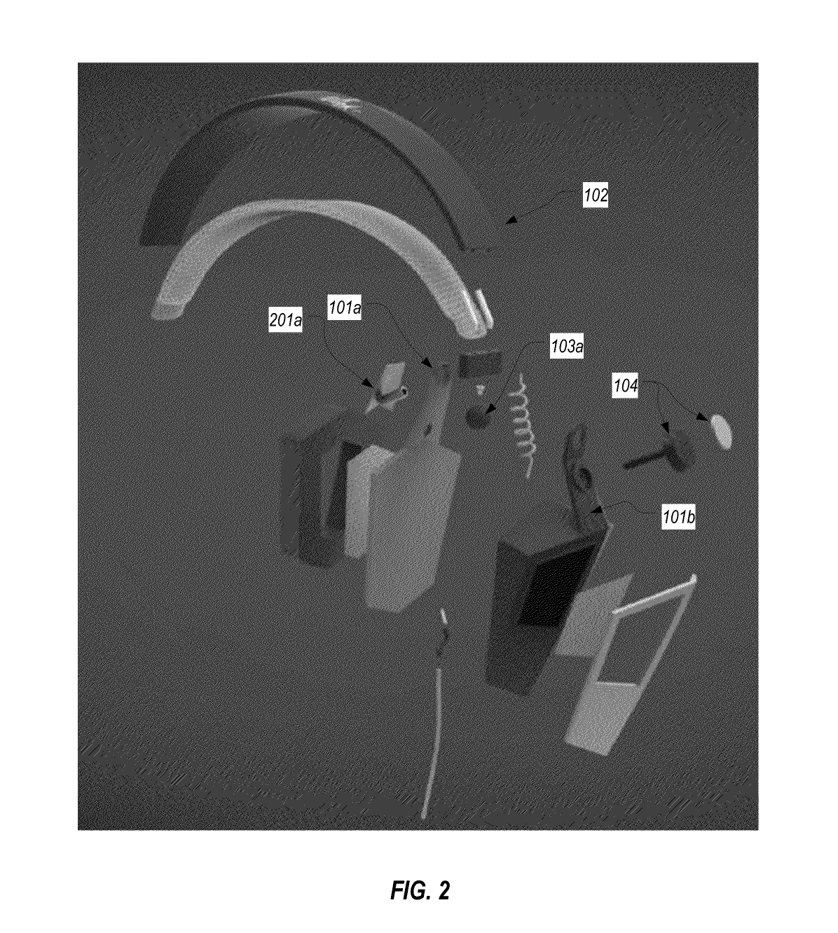

In accordance with some embodiments, FIG. 2 illustrates an exploded view of the headset 100. Additionally FIG. 2 shows that, in some embodiments, the first extension 101a employs a separate threaded component 201a for receiving the tension screw 104. In this regard, one potential benefit of employing a separate threaded component 201a is to facilitate manufacturing. For example, in some embodiments, the inside surface of the threaded component 201a (i.e., the surface that would face the user's head) has a decorative finish that differs from the finish on the first extension 101a.

As stated above, in some embodiments, other tensioning means other than the tension screw 104 are used. For example, a biasing component could be used in place of threaded component 201a. In such cases, the biasing component can apply an inward force on the first 101a and/or second 101b extension to hold the first and second extensions against the rounded object 103a.

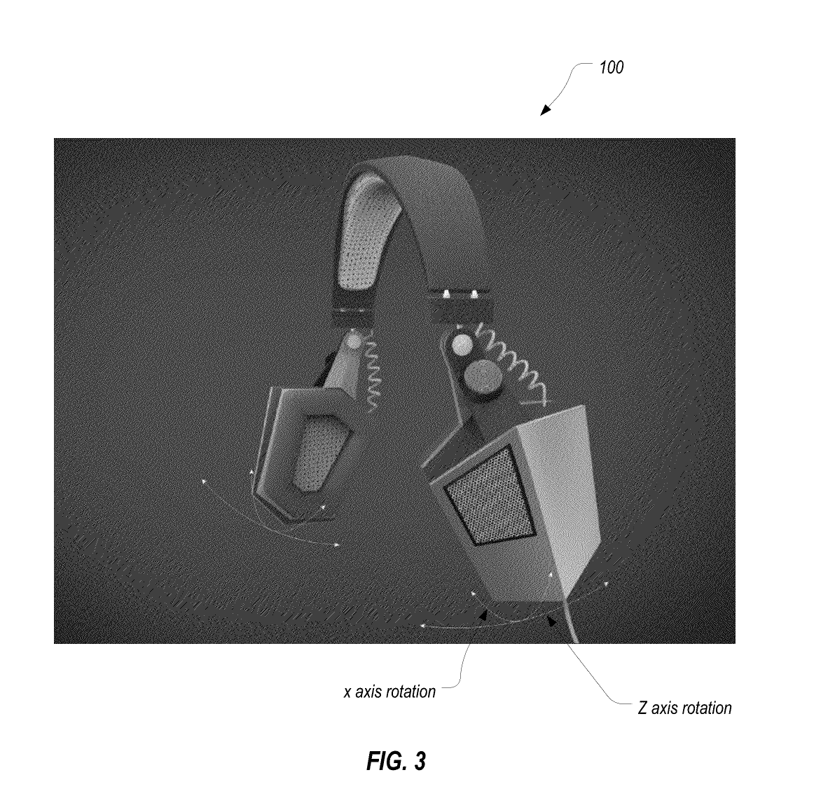

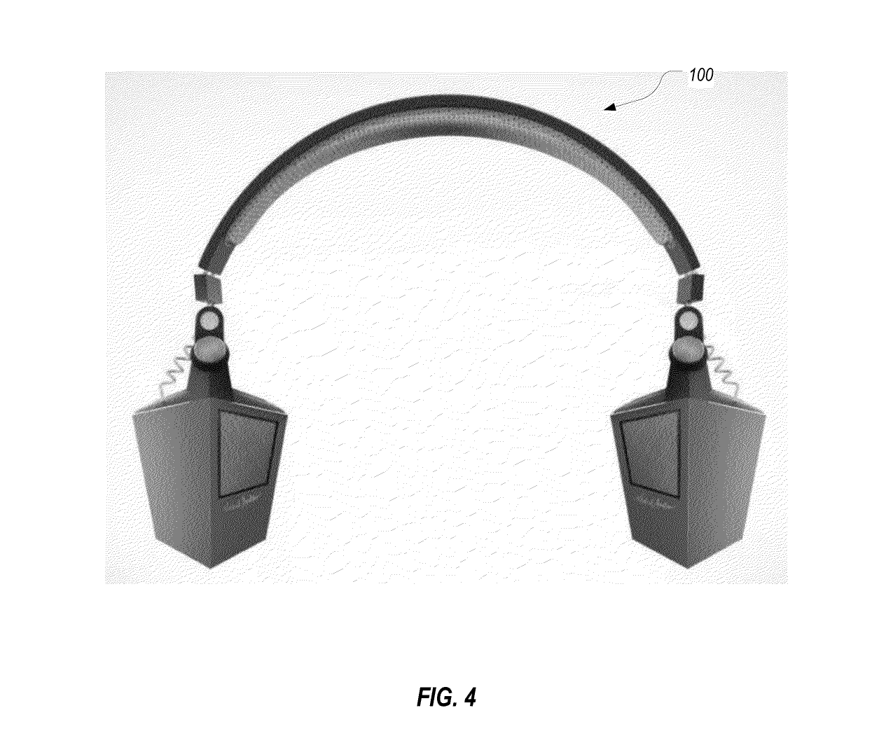

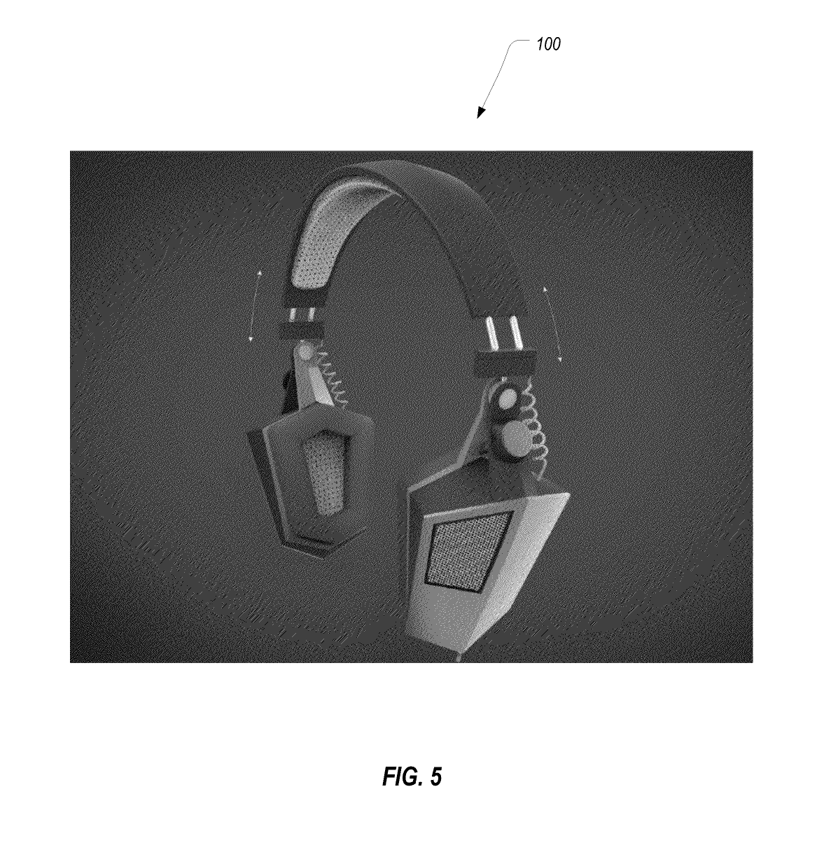

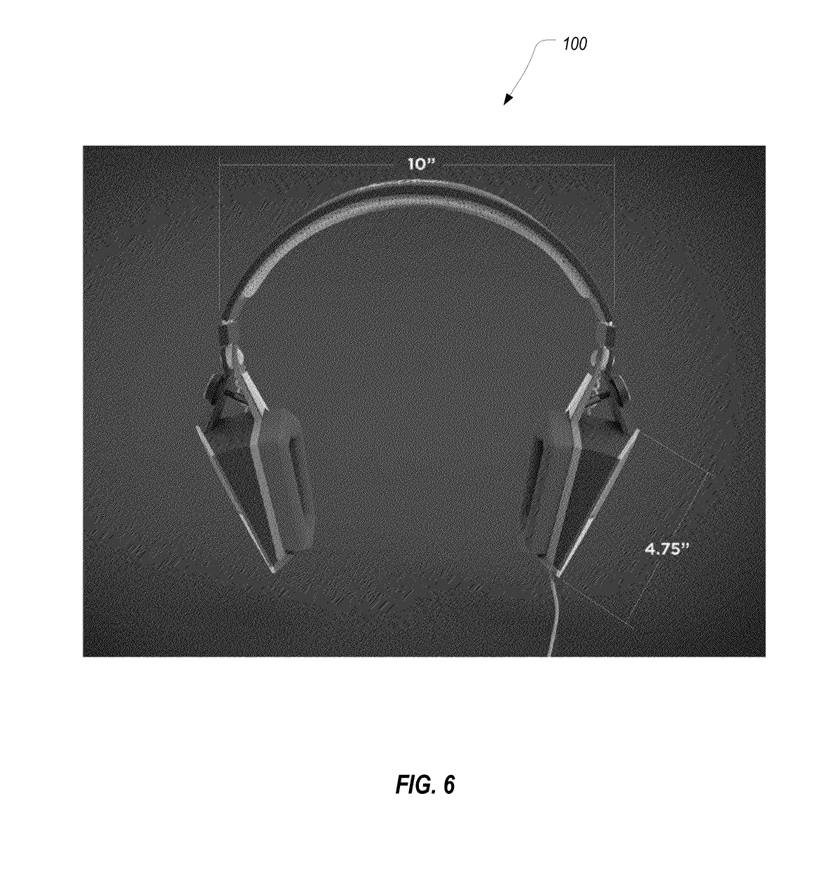

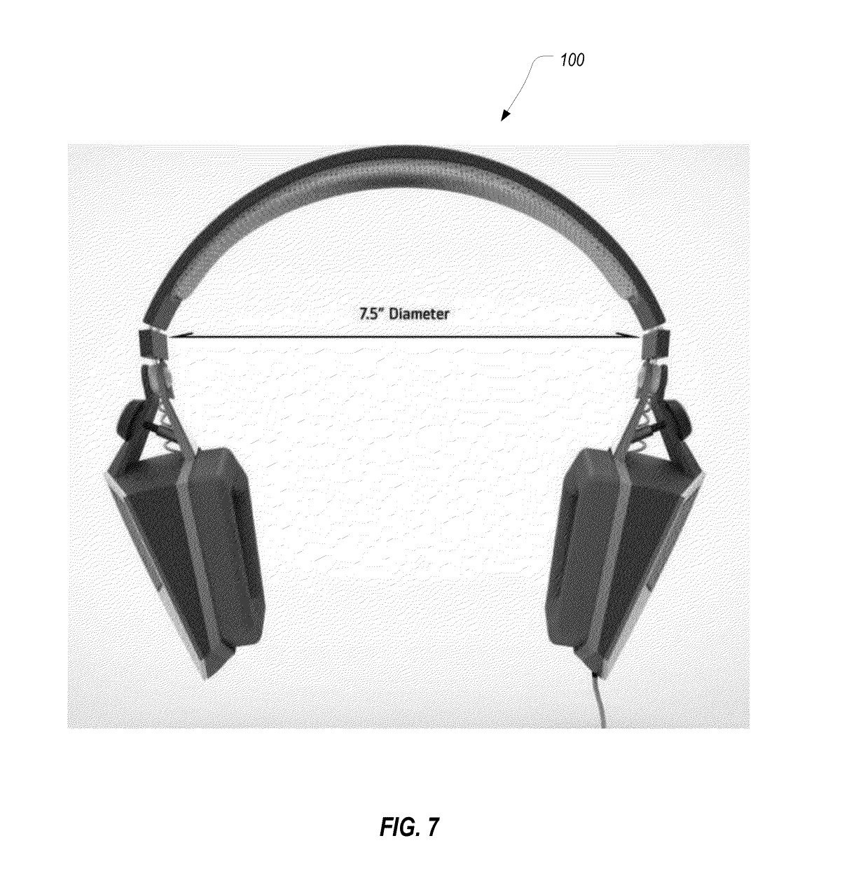

In accordance with some embodiments, FIG. 3 illustrates how earpieces 101 can be rotated around the z axis (i.e., an axis passing through a first and a second rounded object 103a on the headset 100) and the x axis. FIG. 4 illustrates a representative embodiment in which the earpieces 101 have been rotated around the y axis. FIG. 5 illustrates how, in accordance with some embodiments, band 102 can be extended. Additionally, FIGS. 6 and 7 illustrate various non-limiting examples of dimensions that headset 100 may have in one or more embodiments.

Thus, as discussed herein, embodiments of the present invention relate to headsets. In particular, some implementations of the present invention relate to systems and methods for providing a headset with one or more speakers and/or other earpieces that are connected to a headband (or other earpiece support) via one or more ball joints. In some such implementations, the ball joints allow the earpieces to be moved into (and to be held in) a wide variety of orientations.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation, and use may be made without departing from the principles and concepts set forth herein. Also, as used herein, the examples, implementations, and embodiments, in all respects, are meant to be illustrative only and should not be construed to be limiting in any manner. In addition, as the terms on, disposed on, attached to, connected to, coupled to, etc. are used herein, one object (e.g., a material, element, structure, member, etc.) can be on, disposed on, attached to, connected to, or coupled to another object—regardless of whether the one object is directly on, attached, connected, or coupled to the other object, or whether there are one or more intervening objects between the one object and the other object. Also, directions (e.g., on top of, below, above, top, bottom, side, up, down, under, over, upper, lower, x-axis, y-axis, z-axis, etc.), if provided, are relative and provided solely by way of example and for ease of illustration and discussion and not by way of limitation. Furthermore, where reference is made herein to a list of elements (e.g., elements a, b, c), such reference is intended to include any one of the listed elements by itself, any combination of less than all of the listed elements, and/or a combination of all of the listed elements. Also, as used herein, the terms a, an, and one may each be interchangeable with the terms at least one and one or more.

What is claimed:

1. A headset, comprising:
an earpiece configured to be worn in close proximity to a user's ear;
an earpiece support configured to attach to a user's head; and
a ball joint that adjustably couples the earpiece to the earpiece support, wherein the ball joint comprises:
a rounded object, and
a first and a second extension that are configured to apply pressure to the rounded object to adjustably hold the earpiece in relation to the earpiece support.

2. The headset of claim 1, wherein the rounded object comprises a spherical object.

3. The headset of claim 1, wherein the rounded object is coupled to the earpiece support and the extensions are coupled to and extend from the earpiece.

4. The headset of claim 1, wherein the earpiece support comprises a headband.

5. The headset of claim 1, wherein the earpiece support comprises a hardhat.

6. The headset of claim 1, wherein the earpiece comprises a loudspeaker.

7. The headset of claim 1, wherein the ball joint comprises a threaded member that is configured to be tightened and loosened to adjust the pressure that is applied by the extensions to the rounded object.

8. Headphones comprising:
a band configured to be worn around a portion of a user's head;
at least one speaker unit connected to an end portion of the band; and
a ball joint that adjustably couples the at least one speaker unit to the headband, wherein the ball joint comprises:
a rounded object, and
a first and a second extension that are configured to apply pressure to the rounded object to adjustably hold the at least one speaker unit in relation to the band.

9. The headphones of claim 8, wherein the at least one speaker unit comprises two speaker units.

10. The headphones of claim 8, wherein the rounded object is coupled to and extends from the band, and wherein the first and second extensions are couple to and extend from the speaker unit.

11. The headphones of claim 8, wherein the ball joint further comprises a tension screw that is configured to adjustably force the first and second extensions together to impede movement between the rounded object and the first and second extensions.

12. Headphones comprising:
a band having a first rounded object attached at a first end and a second rounded object attached at a second end;
a first speaker unit having a first and a second extension that are configured to adjustably apply pressure the first rounded object to adjustably maintain the first speaker unit in first orientation with respect to the band; and
a second speaker unit having a third and a fourth extension that are configured to adjustably apply pressure the second rounded object to adjustably maintain the second speaker unit in second orientation with respect to the band.

13. The headphones of claim 12, further comprising:
a first tensioning means for forcing a portion of the first extension toward the second extension to adjustably impede movement between the first rounded object and the first speaker unit.

14. The headphones of claim 12, wherein the first tensioning means comprises a threaded object.

15. The headphones of claim 12, wherein the first extension and the second extension are biased together to prevent movement between the first rounded object and first and second extensions.

16. The headphones of claim 12, further comprising:
a first release means for reducing the pressure applied by the first and second extensions on the first rounded object to allow movement between the first rounded object and the first and second extensions.

17. The headphones of claim 12, wherein the first rounded object comprises rubber.

18. The headphones of claim 12, wherein at least one of the first and the second extensions include at least one of a hole and a recess which is configured to receive the first rounded object.

19. The headphones of claim 18, wherein at least one of the first and the second extensions comprises an angled portion and a flat portion with the at least one of the hole and the recess being defined in the flat portion.

20. The headphones of claim 12, wherein the first speaker unit is configured to rotate about the first rounded object about an x axis of rotation, about a y axis of rotation, and about a z axis of rotation.
